(19) United States
(12) Patent Application Publication
(10) Pub. No.: US 2026/0003549 A1
(43) Pub. Date: Jan. 1, 2026

(54) METHOD AND SYSTEM FOR PROFILE MANAGEMENT SYSTEM WITH ENHANCED PRINTING OPTIONS

(71) Applicant: Konica Minolta Business Solutions U.S.A., Inc., Ramsey, NJ (US)

(72) Inventors: Ann Qiongying FENG, San Jose, CA (US); Randy Cruz SORIANO, San Leandro, CA (US)

(73) Assignee: Konica Minolta Business Solutions U.S.A., Inc., Ramsey, NJ (US)

(21) Appl. No.: 18/757,907

(22) Filed: Jun. 28, 2024

(51) Int. Cl. G06F 3/12; G06F 21/32; G06F 21/34

(52) U.S. Cl. CPC G06F 3/1208; G06F 21/32; G06F 21/34

(57) ABSTRACT

A method, non-transitory computer readable-medium, and a printer for profile management of printers are disclosed. The method includes: receiving, by a printer, a print job containing a color profile requirement from a user; checking, by the printer, the color profile requirement for a color space match; determining, by the printer, if the color space match of the color profile requirement is met by the printer; checking, by the printer, access requirements for the color profile requirement for the user; and printing, by the printer, the print job when the access requirement for the color profile requirement is met for the user.

### FIELD OF THE DISCLOSURE

The present disclosure generally relates to a method and system for profile management with enhanced printing options, and more particularly, a method and system for profile management system with enhanced printing options that includes a multi-color printing system.

### BACKGROUND

Traditional printing systems often lack advanced access controls for multi-color printing jobs, leading to inefficiencies and potential misuse of resources. Users may require different levels of access based on the color space used and specific printer capabilities, complicating the management of print jobs and access permissions.

### SUMMARY

It would be desirable to have a multi-color printing access control system that efficiently manages user access and print outputs based on the color space of the file and the capabilities of the designated printers. The system can apply, for example, access codes and wherein a matching method can ensure that only authorized users can initiate print jobs, which match the color space requirements with the available printer options.

A method is disclosed for profile management of printers, the method comprising: receiving, by a printer, a print job containing a color profile requirement from a user; checking, by the printer, the color profile requirement for a color space match; determining, by the printer, if the color space match of the color profile requirement is met by the printer; checking, by the printer, access requirements for the color profile requirement for the user; and printing, by the printer, the print job when the access requirement for the color profile requirement is met for the user.

A non-transitory computer-readable medium having program instructions embodied therewith, the program instructions executable by a processor on a printer to cause the processor of the printer to perform a process comprising: receiving a print job containing a color profile requirement from a user; checking the color profile requirement for a color space match; determining if the color space match of the color profile requirement is met by the printer; checking access requirements for the color profile requirement for the user; and printing the print job when the access requirement for the color profile requirement is met for the user.

A printer is disclosed comprising: a processor configured to: receive a print job containing a color profile requirement from a user; check the color profile requirement for a color space match; determine if the color space match of the color profile requirement is met by the printer; check access requirements for the color profile requirement for the user; and cause the print job to print when the access requirement for the color profile requirement is met for the user.

It is to be understood that both the foregoing general description and the following detailed description are exemplary and explanatory and are intended to provide further explanation of the invention as claimed.

### BRIEF DESCRIPTION OF THE DRAWINGS

The accompanying drawings are included to provide a further understanding of the invention and are incorporated in and constitute a part of this specification. The drawings illustrate embodiments of the invention and, together with the description, serve to explain the principles of the invention.

FIG. 1 is an illustration of a profile management system with enhanced printing options in accordance with an exemplary embodiment.

FIG. 2 is another illustration of a profile management system with enhanced printing options in accordance with an exemplary embodiment.

FIG. 3 is an illustration of a multifunction printer in accordance with an exemplary embodiment.

FIG. 4 is an illustration of a profile management system with enhanced printing options in accordance with an exemplary embodiment.

FIG. 5 is an example of a profile management system with enhanced printing options in accordance with an exemplary embodiment.

FIG. 6 is another example of a profile management system with enhanced printing options in accordance with an exemplary embodiment.

FIG. 7 is a further example of a profile management system with enhanced printing options in accordance with an exemplary embodiment.

FIG. 8 is an illustration of a profile management system with enhanced printing options in accordance with an exemplary embodiment.

FIGS. 9A and 9B is a flowchart of a profile management system in accordance with an exemplary embodiment.

FIG. 10 is another flowchart of a profile management system in accordance with an exemplary embodiment.

FIG. 11 is an illustration of an exemplary hardware architecture for an embodiment of a computer system.

### DETAILED DESCRIPTION

Reference will now be made in detail to the present preferred embodiments of the invention, examples of which are illustrated in the accompanying drawings. Wherever possible, the same reference numbers are used in the drawings and the description to refer to the same or like parts.

Multifunction peripherals or multifunction printers (MFP) often require users to login so that the managed print services can be implemented. The managed print services can include, for example, user authentication that control identities of users, which can help ensure that users have been authenticated at the MFP before a print job is released and/or printed. In addition, managed print services allow administrators to track and monitor usage in real time through regular, scheduled and on-demand reporting, management and charge back of costs by assigning users to cost centers, entering of billing or project codes before printing a document. Managed print services can also create print rules or policies, which can help ensure, for example, cost management by allowing different user roles to access different devices and features. For example, color printing may be allowed by certain individuals and/or groups and not permitted to other individuals and/or groups.

In accordance with an exemplary embodiment, a multi-color printing access control system is disclosed that efficiently manages user access and print outputs based on the color space of the file and the capabilities of the designated printers. The system can apply, for example, access codes and a matching method to ensure that only authorized users can initiate print jobs, matching the color space requirements with the available printer options.

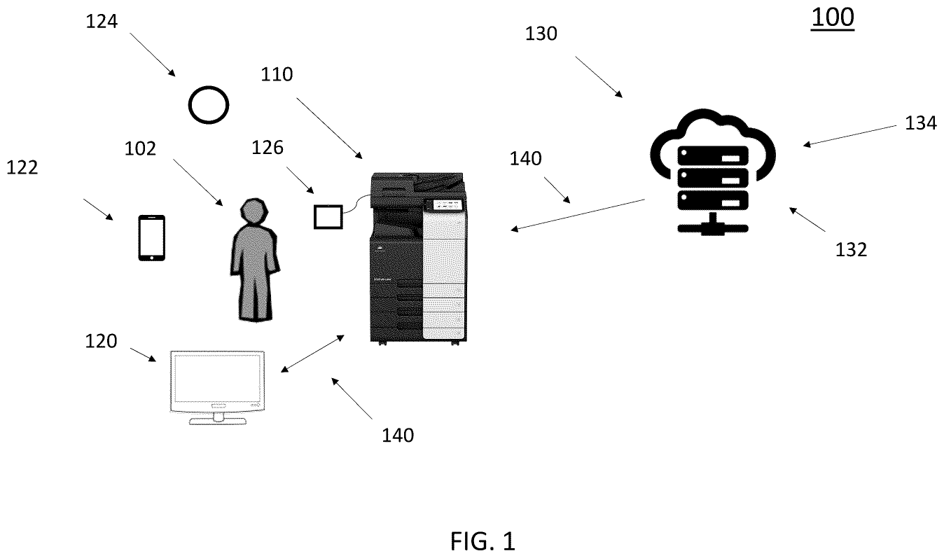

FIG. 1 is an illustration of a system 100 for profile management with enhanced printing options in accordance with an exemplary embodiment. As shown in FIG. 1, the system 100 can include one or more printers or multifunction printers (hereinafter “multifunction printers (MFPs)) 110, a personal computer 120, a client device 122, and a remote server 130. In accordance with an embodiment, the system 100 is configured so that a user 102 that has been authenticated on the one or more multifunction printers 110 can perform a color print job that matches the color space requirements with the available printer options.

In accordance with an exemplary embodiment, the one or more multifunctional printers 110 includes an operation section that applies a color material onto a recording medium and fixes the applied color material. The one or more multifunctional printers 110 is not particularly limited, but includes an engine that forms an image by, for example, an electrophotographic method. The engine forms (develops) a toner image of each of four colors of cyan (C), magenta (M), yellow (Y) and key (K), i.e., CMYK, and an optional fifth (5th) color(S) or color toner color or the like on a photoreceptor based on image data indicating a formation content and transfers the toner image to a recording medium via a transfer member. The one or more multifunction printers 110 can also include a fixing section that fixes the transferred toner on the recording medium by heating and pressing the toner with a roller or the like. For example, the fifth toner color can be white, a clear ink, a gold toner, a silver toner, and the like.

The system 100 can also include one or more users 102 that can be authenticated on the one or more multifunction printers 110, for example, by entry of personal identification number or use of public key infrastructure (PKI) card on the one or more multifunction printers 110, or via an authentication process using, for example, a personal computer 120, a client device 122, a biometric identifier 124, or other authenticator or biometric of the user 102. For example, the user 102 may be authenticated on the one or more multifunction printers 110 via, for example, a fingerprint reader 126 associated with the one or more multifunction printers 110. In accordance with an embodiment, the client device 122 can be, for example, a mobile client, for example, a smart phone, a smart tablet, a smart watch, or a biometric band or the like. The authentication of the user 102 on the one or more multifunction printers 110 can be, for example, for access to the one or more multifunction printers 110. The remote server 130 can be, for example, a cloud computing system 132 that can include one or more servers 134 running in a cloud computing environment that can be accessed by the one or more multifunction printers 110.

The one or more multifunction printers 110, the personal computer 120, the client device 122, and the remote server 130 can include a processor or central processing unit (CPU), and one or more memories for storing software programs and data. The processor or CPU carries out the instructions of a computer program, which operates and/or controls at least a portion of the functionality of the one or more multifunction printers 110, the personal computer 120, the client device 122, and the remote server 130. The one or more multifunction printers 110, the personal computer 120, the client device 122, and the remote server 130 can also include an operating system (OS), which manages the computer hardware and provides common services for efficient execution of various software programs. For example, the software programs can include application software, for example, for managing an authentication module and/or biometric identifier, and/or printer driver software, for example, for the one or more multifunction printers 110, the personal computer 120, the client device 122, and the remote server 130.

In accordance with an embodiment, the one or more multifunction printers 110 can include at least a copy function, an image reading function, a facsimile (fax) function, and a printer function, and forms an image on a sheet based on a print job multifunction peripheral (print instruction) received, for example, from the personal computer 120 or the client device 122. In accordance with an exemplary embodiment, the one or more multifunction printers 110 may only have printing capabilities as disclosed herein. The one or more multifunction printers 110 can include a memory, which stores an identify of one or more users 102 that can be authenticated, for example, via a personal identification number (PIN), a public key infrastructure (PKI) card, or an authentication process using, for example, biometric identifiers of the user 102.

In accordance with an embodiment, the one or more multifunction printers 110 can be configured to host, for example, managed print services (MPS). The managed print services can include, for example, one or more of user authentication, monitoring and reporting, user and cost management, cost accounting and budget management, printer queue management, and workflow management. For example, user authentication can include control over identities of user, which can help ensure that users 102 have been authenticated before a print job is released and/or printed. The monitoring and report features can allow administrators to track and monitor usage in real time through regular, scheduled and on-demand reporting. The user and cost management feature can help manage and charge back costs by assigning users to cost centers, or enabling them to select the relevant cost center, billing codes, or project codes before printing a document. In addition, the user and cost management feature can be used to create print rules or policies, which can help ensure tighter cost management by allowing different user roles to access different devices and features. For example, the user and cost management feature can control, for example, duplex printing and/or color printing to individuals and/or groups.

In addition, cost accounting and budget management provides for cost control and flexibility, which can be used as a print management solution that allows administrators to assign print budgets to users, with the option to top up their accounts. For example, in an environment such as a university, for example, this allows administrators to give students a free print quota that they can add to as required. In addition, a print queue management can be used for management of individual production in addition to office print queues in an office, for example.

The one or more multifunction printers 110, the personal computer 120, the client device 122, and the remote server 130 can be connected via a communication network 140. The communication network 140 may include, for example, a conventional type of network, wired or wireless, and may have any number of configurations, such as a star configuration, token ring configuration, or other known configurations. The communication network 140 may include one or more local area networks (“LANs”), wide area networks (“WANs”) (e.g., the Internet), virtual private networks (“VPNs”), peer-to-peer networks, near-field networks (e.g., Bluetooth®), cellular networks (for example, 3G, 4G, 5G, other generations), and/or any other interconnected data path across which multiple computing nodes may communicate.

In accordance with an exemplary embodiment, the user 102 can present an authenticator to the one or more multifunction printers 110, the client device 122, and/or from the biometric authenticator 124 for access to the one or more multifunction printers 110. For example, the authentication of the user 102 on the one or more multifunction printers 110 can be based on the biometrics of the user 102 via a fingerprint scanner, an IC card or smart card, or other authenticators. In accordance with an exemplary embodiment, the authenticator can be via, for example, a security identification and authentication device (or authenticator), which uses automated methods of verifying or recognizing the identity of a living person based on a physiological or behavioral characteristic. Thus, the user 102 may not be required to manually input passwords to the one or more multifunction printers 110. The method of recognizing the user 102 can include, for example, fingerprints, electrocardiogram (ECG or EKG) information, facial images, iris, and voice recognition. For example, in accordance with an exemplary embodiment, the biometric authenticator 124 can be a wearable device 2, for example, a Nymi™ band, which detection of the user 102 is based on the electrocardiogram (ECG) and its unique properties, e.g., electrical activity of the heartbeat of the user (e.g., wearer) 102 can be used as an authenticator.

Authentication via the client device 120 can also include the presentation, for example, of the client device 122, for example, a mobile device, a smart phone, and/or smart watch of the user 102 to a vicinity of an authenticator (e.g., client device 120) via a near-field communication (NFC) network (e.g., Bluetooth®) and wherein the user 102 has previously been authenticated on the client device 122, for example, the mobile device or smart phone by one or more of a user identifier (ID) and password and/or a biometric identifier, for example, facial recognition, fingerprint, of the like.

In accordance with an exemplary embodiment, the authentication of the user 102 on the client device 120 can be a biometric identifier, which is a distinctive, measurable characteristics used to label and describe or identify an individual, including a metric related to human characteristics. For example, the biometric identifier can include physiological characteristics of an individual including but not limited fingerprints, palm veins, face recognition, DNA (or deoxyribonucleic acid), palm print, hand geometry, iris recognition, retina, and/or odor/scent.

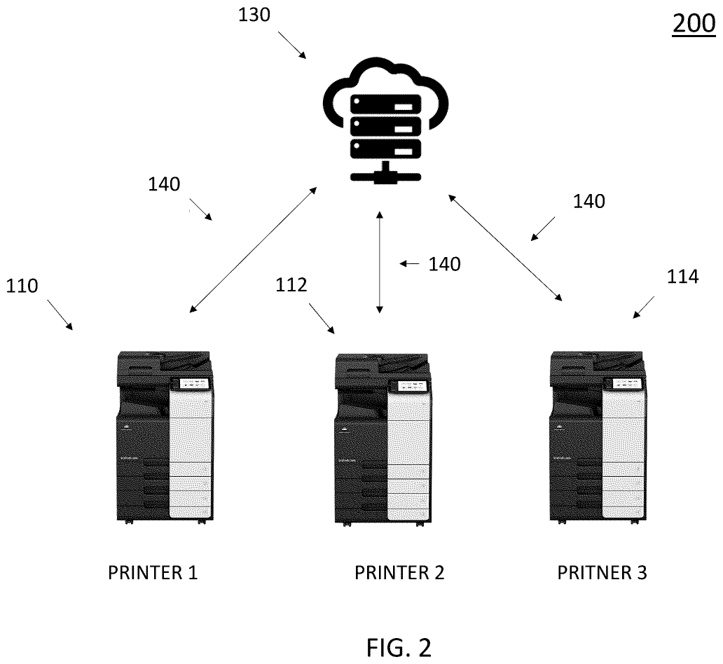

FIG. 2 is another illustration of a profile management system 200 with enhanced printing options in accordance with an exemplary embodiment. As shown in FIG. 2, the profile management system 200 can include a plurality of multifunction printers 110 (Printer 1), 112 (Printer 2), 114 (Printer 3), and a remote server 130. The plurality of multifunction printers 110, 112, 114 and the remote server 130 can be, for example, connected via the communication network 140. Each of the plurality of multifunction printers 110, 112, 114 is preferably a color printer as disclosed herein.

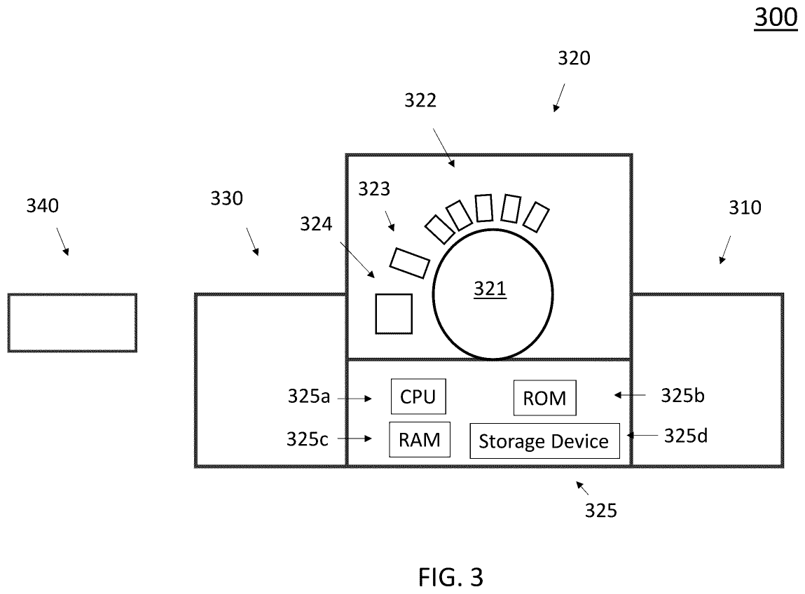

FIG. 3 is an illustration of a multifunction printer 300 in accordance with an embodiment. The multifunction printer 300 can include a sheet feeding device 310, a printer 320, a sheet ejection device 330, and an optional colorimeter 340. The sheet feeding device 310, the printer 320, and the sheet ejection device 330 are connected and disposed in this order from an upstream side to a downstream side in a conveyance direction of a recording medium. The sheet feeding device (an example of a recording medium supply device) can include a container (sheet feeding tray) that contains a recording medium and supplies the recording medium to the printer. The printer 320 can bey, for example, a one-pass UV inkjet printer, and can include a main cylinder 321, a plurality of head units 322, an irradiation unit 323, a scanner 324, and an information processing unit 325. The multifunction printer 320 is not limited to the one-pass UV inkjet printer, and may be, for example, an image forming apparatus that forms an image on a recording medium by an electrophotographic method other than the one-pass UV inkjet printer.

The main cylinder 321 is formed of a cylindrical member and is rotated counterclockwise in the drawing by a drive motor. The main cylinder 321 holds the recording medium along a cylindrical outer peripheral surface and conveys the recording medium along with the rotation of the cylinder. A conveying surface of the main cylinder 321 faces the plurality of head units 322, the irradiation unit 323, and the scanner 324, and the head units 322 and the irradiation unit 323 perform processing related to image formation on the recording medium conveyed by the main cylinder 321. The scanner 324 scans the recording medium on which the image is formed and reads the image (print image) formed on the recording medium. The plurality of head units 322 form an image by ejecting ink droplets to a recording surface of the recording medium moving according to the rotation of the main cylinder 321 at an appropriate timing and causing the ink droplets to land on the recording target surface of the recording medium. The plurality of head units 322 can include, for example, four or five head units 322 that respectively eject inks of four or 5 colors. For example, the four head units 322 include, for example, head units that respectively discharge Y (yellow), M (magenta), C (cyan), and K (black) inks. The five head units 322 can include, for example, head units that respectively discharge Y (yellow), M (magenta), C (cyan), K (black) inks, and S (for example, white, clear, silver, or gold). In addition, the five head units 322 can include one or more additional head units 322, for example, a six head unit or a seven head unit. Accordingly, the number of head units 322 can be five or more, which corresponds to a fifth color or more.

The irradiation unit 323 can include, for example, a fluorescent tube such as a low-pressure mercury lamp and causes the fluorescent tube to emit light to emit energy rays such as ultraviolet rays. The irradiation unit 323 is provided near the outer peripheral surface of the main cylinder 321 and at a position on the downstream side of the head unit 322 in the conveyance direction of the recording medium. Furthermore, the irradiation unit 323 irradiates the recording medium held by the main cylinder 321 and onto which the ink has been discharged with energy rays to cure the ink.

The scanner 324 is an example of an image reader including an image sensor or the like, reads a recording medium on which an image is formed, for example, a test sheet for colorimetry on which a plurality of patches is formed, and outputs a read image to the information processing unit 325.

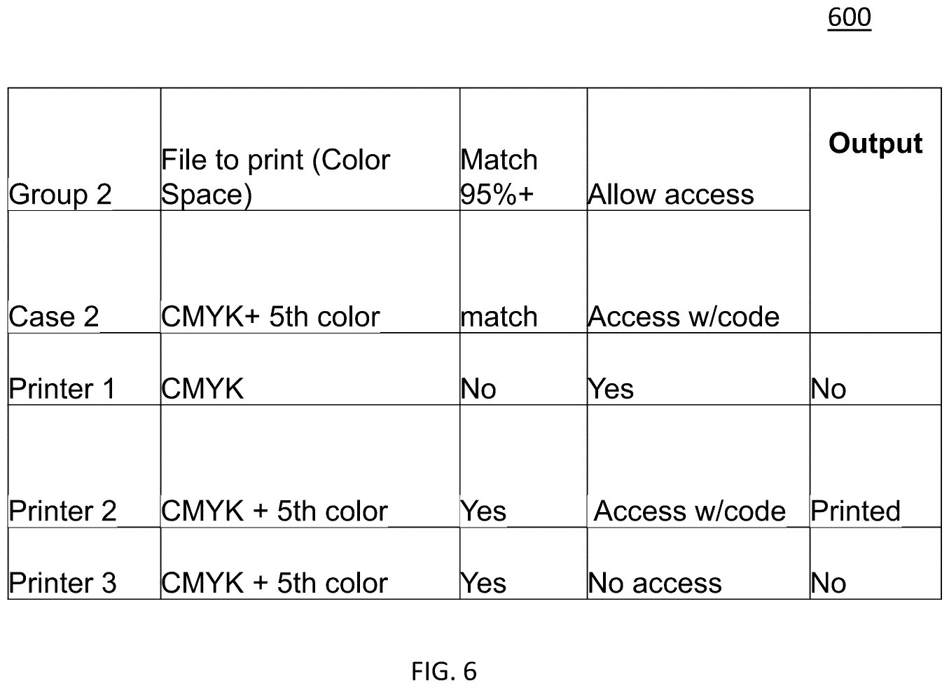

The information processing unit 325 includes a central processing unit (CPU) 325a, a read only memory (ROM) 325b, a random-access memory (RAM) 325c, and a storage device 325d. The information processing unit 325 can includes, for example, a microprocessor or the like, and performs overall control of the printer 320. The information processing unit 325 can be configured inside the printer 220, or alternatively, the information processing unit 325 may be configured, for example, in a personal computer (PC) provided outside the printer 320 and capable of communicating with the printer 320. The CPU 325a controls an operation of the information processing unit 325. The CPU 325a controls, for example, operations of the main cylinder 321, the head units 322, and the irradiation unit 323 to control image forming processing in the printer 320. Furthermore, the CPU 325a controls reading processing on a recording medium on which an image is formed in the scanner 24. Furthermore, the CPU 25a controls colorimetric processing (see FIG. 6 described later) in the information processing unit 25.

The ROM 325b includes, for example, a storage medium such as a nonvolatile memory, and stores programs, data, and the like executed and referred to by the CPU 325a. The ROM 325b is used as an example of a computer-readable non-transitory storage medium storing the program to be executed by the information processing unit 325. The RAM 325c can include, for example, a storage medium such as a volatile memory, and temporarily stores information (data) necessary for processing performed by the CPU 325a.

The storage device 325d is constituted by a computer-readable non-transitory recording medium storing the program to be executed by the CPU 325a and is constituted by a storage device such as a hard disk drive (HDD). The storage device stores a program for the CPU 325a to control each unit, an operating system (OS), a program such as a controller, and data. Note that, a part of the program and data stored in the storage device may be stored in the ROM 325b. Furthermore, the computer-readable non-transitory recording medium storing the program executed by the CPU 325a is not limited to the HDD, and may be a recording medium such as a solid-state drive (SSD), a compact disc (CD)-ROM, or a digital versatile disc (DVD)-ROM. The sheet ejection device 330 includes a container (sheet ejection tray) that contains a recording medium, and stores the recording medium ejected from the printer 320, on which an image is formed,

The colorimeter 340 can include, for example, a spectral colorimeter capable of simultaneously measuring color and gloss and measures a colorimetric value of the test sheet as a pixel value in a color space. Furthermore, the colorimeter 340 outputs the measured colorimetric value of the test sheet, that is, each pixel value, for example, in the Lab color space to the information processing unit 325 of the printer 320 via a universal serial bus (USB) connection port, a local area network (LAN), or the like.

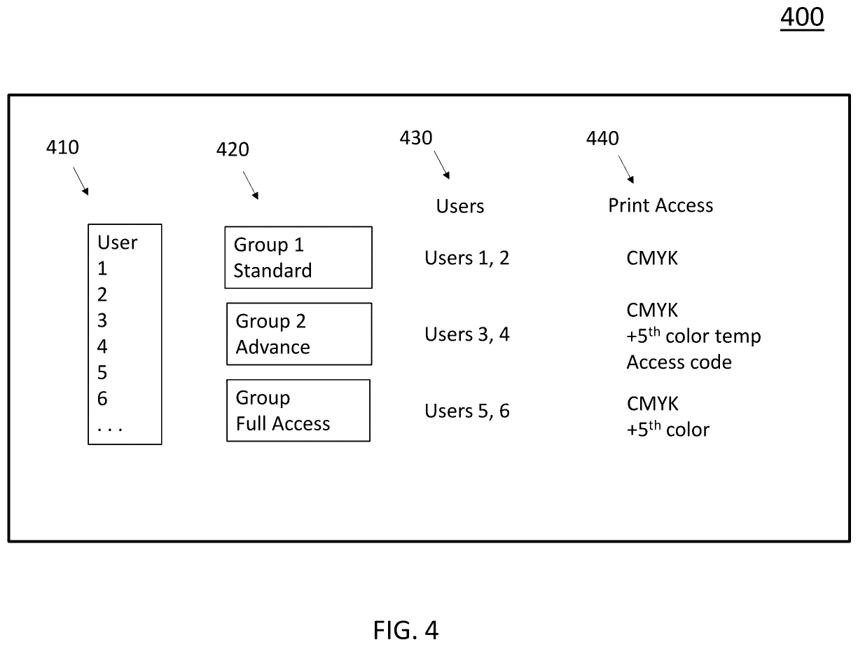

FIG. 4 is an illustration of a profile management system 400 with enhanced printing options in accordance with an exemplary embodiment. As shown in FIG. 4, the profile management system 400 can include a plurality of users 410. Each of the plurality of users 410 can be assigned to a group 420. For example, the Groups 420 can include Group 1, Group 2, and Group 3. Group 1 can be a standard group in which each of the users 410 can print color print jobs using, for example, CMYK color space. Group 2 can be an advance group in which each of the users 410 can print color print jobs using, for example, CMYK color space and CMYK plus a 5th or fifth(S) color toner with an access code. Group 3 can be a full access group in which users 410 can print color print jobs with CMYK color space and CMYK plus a 5^{th}(S) color toner without an access code. The access code can be assigned to each of the users in Group 2 based on one or more factors including temporary access to print one or more color print jobs, use of certain 5^{th}(S) color toners and for example, other 5^{th}(S) color toners may not be allowed. For example, the access code of users 410 in Group 2 may allow printing of color print jobs with a white toner or a clear toner, but not gold or siler toner. Alternatively, the access code may allow the users 410 of Group 2 to print only a certain number of sheets of print media using 5^{th}(S) color toners. For example, the certain number of sheets of print media may be specific to each of the users 410 of Group 2 or each of the users 410 of Group 2 may have the name number of sheets of print media that can be printed within a certain period of time.

As shown in FIG. 4, for example, User 1 and User 2 are assigned to Group 1 and have print access for the CMYK space only. User 3 and User 4 are assigned to Group 2 and have print access for the CMYK space and the CMYK space plus a 5^{th}(S) color with an access code, for example, a temporary access code that allows the user 410, i.e., User 3 and User 4 to print a color print job only with the access code. User 5 and User 6 are assigned to Group 3 and have print access to the CMYK space and the CMYK space plus a 5^{th}(S) color without an access code, i.e., full access.

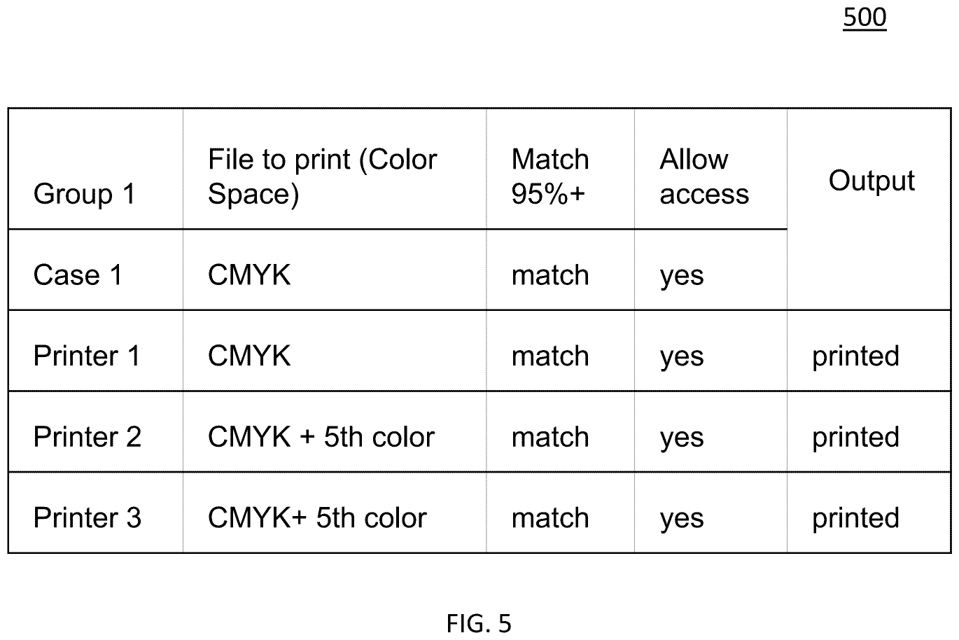

FIG. 5 is an example of a profile management system 500 with enhanced printing options in accordance with an exemplary embodiment. As shown in FIG. 5, Group 1 allows users to print color print job with the CMYK color space. For example, with users in Group 1, color print jobs having a profile requirement for a color that can be printed on a printer with a CMYK color space can be reproduced by a multifunction printer. In accordance with an embodiment, as shown in FIG. 2, the system 200 can include a plurality of printers 110 (Printer 1), 112 (Printer 2), and 114 (Printer 3). Printer 1 can reproduce a print job based on a CMYK color space. Printers 2 and 3, for example, can reproduce a print job based on a CMYK profile plus a 5^{th} color (or color toner). As shown in FIG. 5, for Case 1, a color print job requiring a CMYK color space, the color print job can be printed for a user 102 within Group 1 on Printers 1, 2, and 3 with a color match, for example, of 95% or greater. The color match, for example, can be greater than 95%, for example, 96% or greater, 97% or greater, 98% or greater, 99% or greater.

In accordance with an embodiment, a color space can be a specific organization of colors. In combination with color profiling supported by various physical devices, the color space supports reproducible representations of color by the multifunction printer 110, 112, 114, whether such representation entails an analog or a digital representation. For example, a color space may be arbitrary, for example, with physically realized colors assigned to a set of physical color swatches with corresponding assigned color names (including discrete numbers in, for example, the Pantone collection), or structured with mathematical rigor. In addition, the color space can also be a useful conceptual tool for understanding the color capabilities of a particular device or digital file. When trying to reproduce color on another device, color spaces can show whether shadow/highlight detail and color saturation can be retained, and by how much either will be compromised. In accordance with an exemplary embodiment, the multifunction printers 110, 112, 114 can include a piece of software code that ensures precise and consistent color management by describing the range of colors that the multifunction printer can reproduce based on the profile requirement of the print job.

FIG. 6 is another example of a profile management system 600 with enhanced printing options in accordance with an exemplary embodiment. As shown in FIG. 6, the profile management system 600 for a Case 2 in which users (i.e., User 3 and User 4) in Group 2 can print color print job that requires a 5^{th}(S) color in addition to the CMYK color space with an access code. In accordance with an exemplary embodiment, for example, if the color print job is sent to multifunction printer 110 (i.e., Printer 1), which includes on the CMYK color space, the multifunction printer 110 will not be able to print the color print job since the multifunction printer 110 does not have the 5^{th}(S) toner. However, for example, Printer 2 (multifunction printer 112) includes the CMYK color space and a 5^{th}(S) color toner and if the access code is received and matches the code for User 3 or User 4, the color print job from either User 3 or User 4 can be executed or printed. Printer 3 (multifunction printer 114) is configured with the CMYK profile and a 5^{th}(S) toner, however, in the present example, for example, Printer 3 (multifunction printer 114) can be configured such that only users 102 with full access are able to use the multifunction printer 114. For example, Printer 3 (multifunction printer 114) may include a special toner, for example, a silver toner or a gold toner that due to costs associated with the toner, that only users 102 from Group 3 will have access to the multifunction printer 114. In addition, additional colors, for example, a special toner can also require additional processing power and/or time associated therewith for generating the print data.

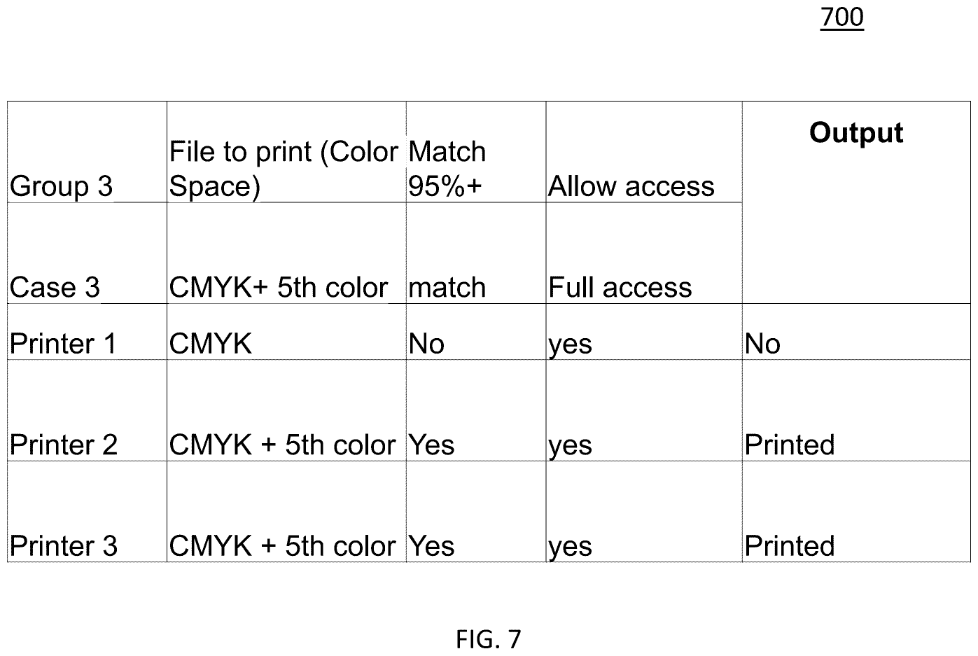

FIG. 7 is a further example of a profile management system 700 with enhanced printing options in accordance with an exemplary embodiment. As shown in FIG. 7, for members of Group 3, for example, User 5 and User 6, for a color print job that requires a CMYK color space plus a 5^{th}(S) color toner (i.e., Case 3), each of the multifunction printers 110, 112, 114, will first determine if the multifunction printer 110, 112, 114, can reproduce the color profile of the color print job. For example, since Printer 1 (multifunction printer 110) includes only a CMYK color space capabilities, Printer 1 can determine that a color space match, for example, of at least 95% of the color cannot be met, and Printer 1 will not print the color print job. Meanwhile, since members of Group 3 have full access, the color print job can be printed by both Printer 2 (multifunction printer 112) and Printer 3 (multifunction printer 114), which each include the CMYK color space and a 5^{th}(S) color toner.

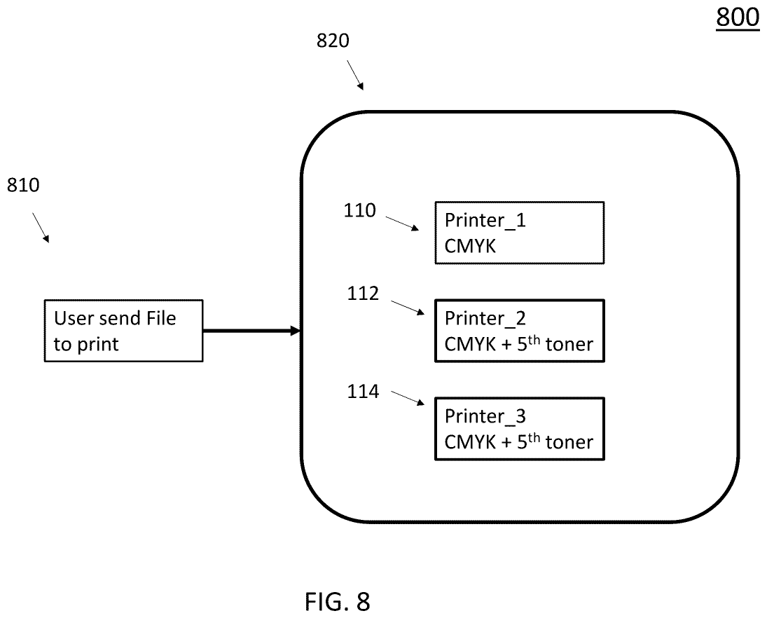

FIG. 8 is an illustration of a profile management system 800 with enhanced printing options in accordance with an exemplary embodiment. As shown in FIG. 8, the user 102 sends a color print job (or file) 810 to one or more multifunction printers 820 to printed as disclosed herein. For example, the one or more multifunction printers 820 can include Printer 1 (multifunction printer 110), Printer 2 (multifunction printer 112), and Printer 3 (multifunction printer 114). As set forth above, in particular cases, only member of a certain group or with an access code can print, for example, on Printer 2 (multifunction printer 110) or Printer 3 (multifunction printer 112). For example, for Printer 3 (multifunction printer 114), only members of Group 3 that have full access will be able to print a color print job on Printer 3 (multifunction printer 114).

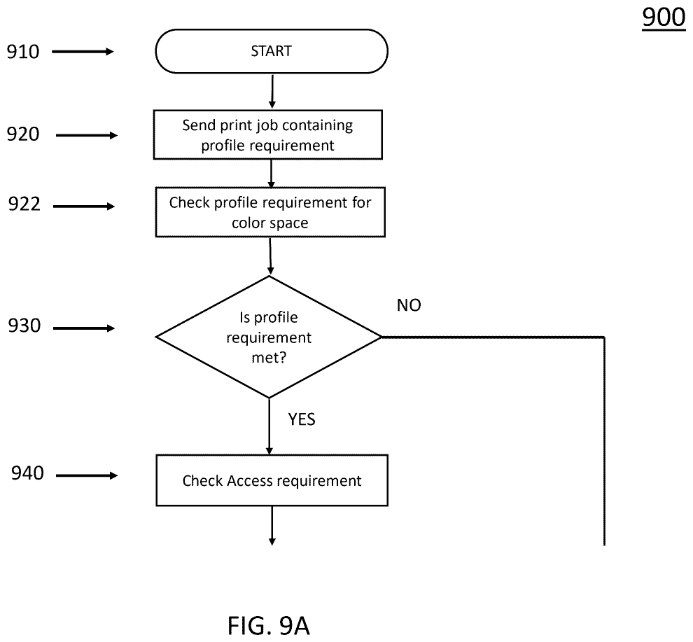

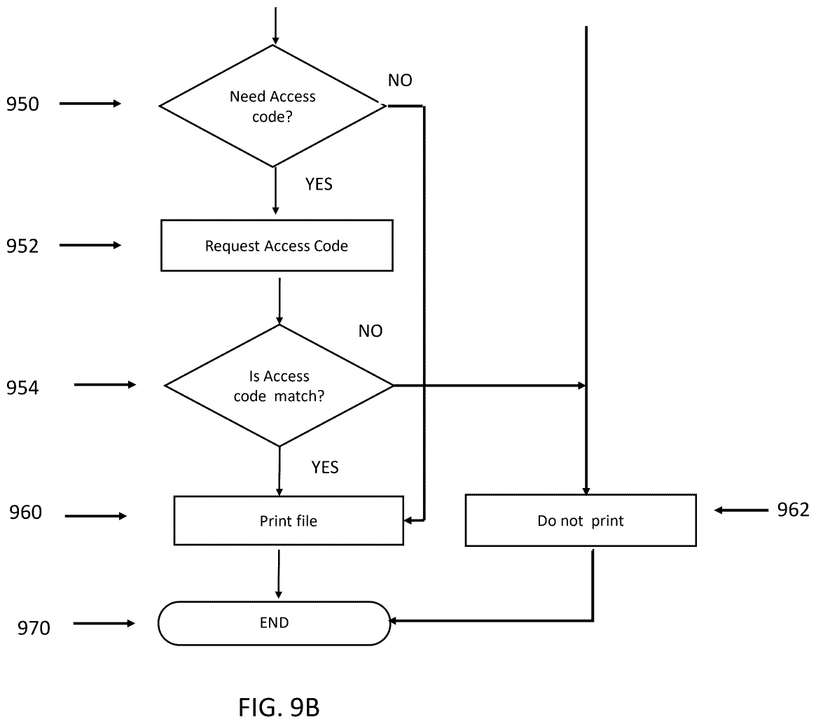

FIGS. 9A and 9B is a flowchart of a profile management system 900 in accordance with an exemplary embodiment. As shown in FIGS. 9A and 9B, the profile management system 900 starts in step 910. In step 920, a print job (i.e., a color print job) is sent containing a profile requirement. In accordance with an exemplary embodiment, the profile requirement can include a color profile. The color profile can be obtained with a printer or multifunction printer 110, 112, 114, for example, with a CMYK color space (or color profile) or the color profile may require a printer or multifunction printer 112, 114 with a CMYK color space plus a 5^{th}(S) color toner in order to meet or obtain the profile requirement set forth in the print job. In step 922, the color profile requirement for the color space is checked by the printer or multifunction printer 110, 112, 114, to determine if the multifunction printer 110, 112, 114, can be meet the requirements. For example, if the color profile requirement of the print job requires a 5^{th}(S) color, for example, a white, a clear, a silver, or a gold toner, a printer or multifunction printer 110, 112, 114, may not be able to reproduce the print job within a predetermined color profile match. For example, the predetermined color profile match may require that at least 95% of the colors of the print job can be reproduced by the printer or multifunction printer 110, 112, 114.

In accordance with an embodiment, based on the determination or check performed in step 922 by the printer or multifunction printer 110, 112, 114, the process continues to step 930 in which the results of step 922 are received. If the profile requirement for color space of the print job cannot be met by the printer or multifunction printer 110, 112, 114, the process continues to step 962 in which a notification, for example, can be sent to the user 102 that the print job cannot be printed since the printer or multifunction printer 110, 112, 114, cannot meet the profile requirements for the color space of the print job. For example, the printer or multifunction printer 110, 112, 114, may only have the capability of producing a CMYK color space (or color space) rather than a 5^{th}(S) color as required to obtain a color match of a predetermined percentage. Accordingly, in step 962, the print job is not printed.

However, if the printer or multifunction printer 110, 112, 114, can obtain the required color match set forth in the profile requirements for the color space of the print job, the process continues to step 940 in which the access requirements for profile requirements for the color space of the print job are checked. For example, as set forth above and shown in FIGS. 5-7, in step 950, a determination is made if the user 102 needs to submit an access code for the execution of the print job. If an access code is not needed, the process continues to step 960 in which the print job is printed by the printer or multifunction printer 110, 112, 114. However, if in step 950 an access code is needed, in step 952, the printer or multifunction printer 110, 112, 114 can send a request to the user 102 to provide the access code for the print job. For example, the access code can be obtained from a supervisor that can authorize the print job. In step 954, the printer or multifunction printer 110, 112, 114 receives the access code from the user 102, via an input on a panel associated with the printer or multifunction printer 110, 112, 114, or via input into a personal computer, a smart device or the like. The printer or multifunction printer 110, 112, 114, receives the access code and determines if the access code matches an access code stored in the printer or multifunction printer 110, 112, 114, or alternatively, an access code retrieved from a remote server or managed print server 130. If the access code matches the stored or retrieved access code, the print job is printed in step 960. Alternatively, if the access code is not received or does not match the stored or retrieved code, the print job is not printed and notification or the like can be sent to the user 102 in step 962. The process ends in step 970.

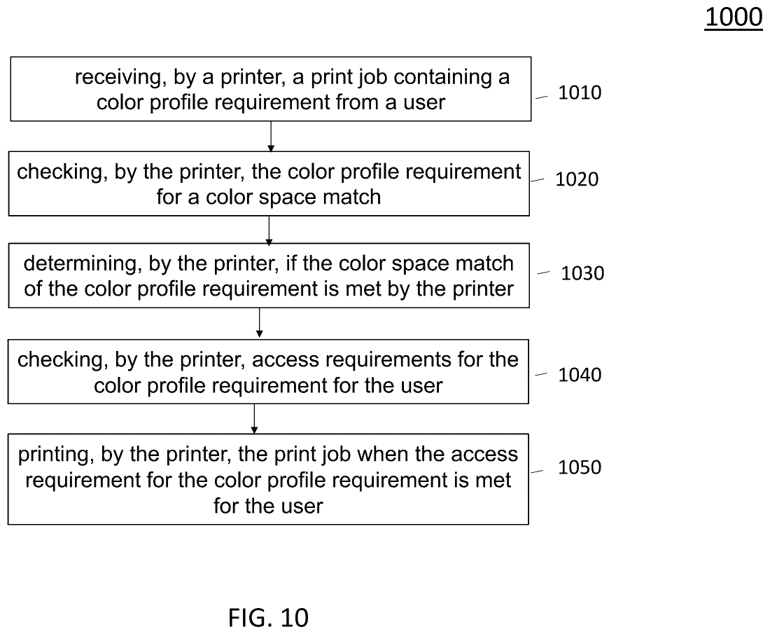

FIG. 10 is another flowchart of a profile management system 1000 in accordance with an exemplary embodiment. As shown in FIG. 10, in step 1010, a printer 110, 112, 114 receives a print job containing a color profile requirement from a user. In step 1020, the printer 110, 112, 114 checks the color profile requirement for a color space match. In step 1030, the printer 110, 112, 114 determines if the color space match of the color profile requirement is met by the printer 110, 112, 114. In step 1040, the printer 110, 112, 114 checks access requirements for the color profile requirement for the user. In step 1050, the printer 110, 112, 114 prints the print job when the access requirement for the color profile requirement is met for the user.

In accordance with an embodiment, the method can further include receiving, by the printer 110, 112, 114, an authenticator from the user for access to the multifunction; and determining, by the printer 110, 112, 114, an access level for the user based on the authenticator received by the printer 110, 112, 114. For example, the method can include printing, by the printer 110, 112, 114, the print job when the access level for the user is equal to or greater than the access lever for the print job. The method can further include, for example, restricting, by the printer 110, 112, 114, access to the printer 110, 112, 114 with the CMYK color space plus the one or more additional colors to only a certain group of users, the certain group of users having access to all printers 110, 112, 114 within a network of printers 110, 112, 114.

In accordance with an embodiment, the method further includes requesting, by the printer 110, 112, 114, an access code from the user to execute the print job; receiving, by the printer 110, 112, 114, the access code from the user to execute the print job; and determining, by the printer 110, 112, 114, if the access code received from the user matches an access code for the user to execute the print job.

In accordance with an embodiment, the access level for the user includes access to one or more of a printer 110, 112, 114 with a CMYK color space or a printer 110, 112, 114 with a CMYK color space plus one or more additional colors.

In accordance with another embodiment, the method includes wherein the checking by the printer 110, 112, 114 the access requirements for the color profile requirement for the user comprises: forwarding, by the printer 110, 112, 114, the authenticator received from the user to a remote server with a request to authenticate the user on the printer 110, 112, 114; and receiving, by the printer 110, 112, 114, the access requirements for the color profile requirement for the user.

In accordance with an embodiment, the authenticator received from the user on the printer 110, 112, 114 comprises: receiving, the biometric authenticator on a biometric authenticator device associated with the printer 110, 112, 114, the biometric authenticator device including one or more of a sensor, a scanning device, or an electronic reader, and wherein the biometric identifier of the user being at least one physiological characteristic of the user, and wherein the at least one physiological characteristic is selected from one or more of fingerprints, palm veins, face recognition, DNA (deoxyribonucleic acid), palm print, hand geometry, iris recognition, retina, and/or odor/scent; receiving, the smart card on a card reader associated with the printer 110, 112, 114; and receiving, by the printer 110, 112, 114, the authenticator from the user via a client device via a wireless communication protocol, the wireless protocol being a near-field communication (NFC) or a Bluetooth technology standard, and wherein the client device is a mobile device, a smart phone, or a wearable device.

In accordance with an embodiment, the method further includes determining, by the printer 110, 112, 114, that the color space match of the color profile requirement is met by the printer 110, 112, 114 when the printer 110, 112, 114 can achieve a predetermined percentage of matching of a color space for the color print job.

In accordance with another embodiment, the method includes a plurality of users, each of the plurality of users having an access level, the access level for each of the plurality of users including no access to the printer 110, 112, 114 with a CMYK color space, access to the printer 110, 112, 114 with the CMYK color space, access to the printer 110, 112, 114 with the CMYK color space plus one or more additional colors with an access code, and access to the printer 110, 112, 114 with the CMYK color space plus the one or more additional colors without the access code. For example, the method can include receiving, by the printer 110, 112, 114, a request to transfer the color print job to the at least one of the one or more of the plurality of printer 110, 112, 114 with the CMYK color space plus a fifth color or more; and forwarding, by the printer 110, 112, 114, the color print job to the at least one of the one or more of the plurality of printer 110, 112, 114 with the CMYK color space plus the fifth color or more to be printed.

In accordance with an embodiment, the method further includes notifying, by the printer 110, 112, 114, the user when the user does not have the access requirements for the color profile requirement for the color print job.

In accordance with another embodiment, the printers 110, 112, 114 comprise a plurality of printers 110, 112, 114, and one or more of the plurality of printers 110, 112, 114 has a CMYK color space plus a fifth color or more, and wherein the method further includes: finding, by the printer 110, 112, 114, at least one of the one or more of the plurality of printers 110, 112, 114 when the color print job requires the CMYK color space plus the fifth color or more; and notifying, by the printer 110, 112, 114, the user of the at least one of the one or more of the plurality of printers 110, 112, 114 with the CMYK color space plus the fifth color or more.

In accordance with an embodiment, the method can include receiving, by the printer 110, 112, 114, the color profile requirement of the print job in one or more color modes, the one or more color modes including one of CMYK, LAB, sRGB and Adobe® RGB; converting, by the printer 110, 112, 114, the one or more color modes of the print job to a CMYK color space; determining, by the printer 110, 112, 114, if the converted CMYK color space is met by the printer 110, 112, 114; and printing, by the printer 110, 112, 114, the print job when the converted CMYK color space match is met by the printer 110, 112, 114. The one or more color modes are not limited to CMYK, LAB, sRGB and Adobe® RGB, and may be another color mode.

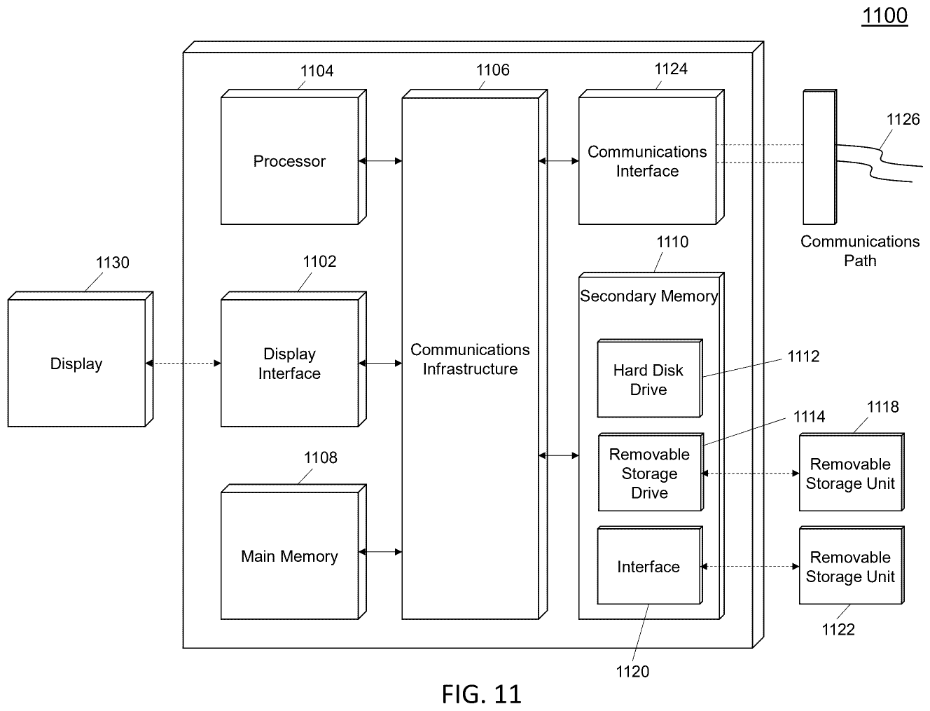

FIG. 11 illustrates a representative computer system 1100 in which embodiments of the present disclosure, or portions thereof, may be implemented as computer-readable code executed on hardware. For example, the one or more printers or multifunction printers 110, 112, 114, the personal computer 120, the client device 122, the wearable device 124, the fingerprint reader 126, and the remote server 130 associated with the method and system for profile management with enhanced printing options as disclosed herein may be implemented in whole or in part by a computer system 1100 using hardware, software executed on hardware, firmware, non-transitory computer readable media having instructions stored thereon, or a combination thereof and may be implemented in one or more computer systems or other processing systems. Hardware, software executed on hardware, or any combination thereof may embody modules and components used to implement the methods and steps of the presently described method and system.

If programmable logic is used, such logic may execute on a commercially available processing platform configured by executable software code to become a specific purpose computer or a special purpose device (for example, programmable logic array, application-specific integrated circuit, etc.). A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above-described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 1118, a removable storage unit 1122, and a hard disk installed in hard disk drive 1112.

Various embodiments of the present disclosure are described in terms of this representative computer system 1100. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

A processor device 1104 may be processor device specifically configured to perform the functions discussed herein. The processor device 1104 may be connected to a communications infrastructure 1106, such as a bus, message queue, network, multi-core message-passing scheme, etc. The network may be any network suitable for performing the functions as disclosed herein and may include a local area network (“LAN”), a wide area network (“WAN”), a wireless network (e.g., “Wi-Fi”), a mobile communication network, a satellite network, the Internet, fiber optic, coaxial cable, infrared, radio frequency (“RF”), or any combination thereof. Other suitable network types and configurations will be apparent to persons having skill in the relevant art. The computer system 1100 may also include a main memory 1108 (e.g., random access memory, read-only memory, etc.), and may also include a secondary memory 1110. The secondary memory 1110 may include the hard disk drive 1112 and a removable storage drive 1114, such as a floppy disk drive, a magnetic tape drive, an optical disk drive, a flash memory, etc.

The removable storage drive 1114 may read from and/or write to the removable storage unit 1118 in a well-known manner. The removable storage unit 1118 may include a removable storage media that may be read by and written to by the removable storage drive 1114. For example, if the removable storage drive 1114 is a floppy disk drive or universal serial bus port, the removable storage unit 1118 may be a floppy disk or portable flash drive, respectively. In one embodiment, the removable storage unit 1118 may be non-transitory computer readable recording media.

In some embodiments, the secondary memory 1110 may include alternative means for allowing computer programs or other instructions to be loaded into the computer system 1100, for example, the removable storage unit 1122 and an interface 1120. Examples of such means may include a program cartridge and cartridge interface (e.g., as found in video game systems), a removable memory chip (e.g., EEPROM, PROM, etc.) and associated socket, and other removable storage units 1122 and interfaces 1120 as will be apparent to persons having skill in the relevant art.

Data stored in the computer system 1100 (e.g., in the main memory 1108 and/or the secondary memory 1110) may be stored on any type of suitable computer readable media, such as optical storage (e.g., a compact disc, digital versatile disc, Blu-ray disc, etc.) or magnetic storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 1100 may also include a communications interface 1124. The communications interface 1124 may be configured to allow software and data to be transferred between the computer system 1100 and external devices. Exemplary communications interfaces 1124 may include a modem, a network interface (e.g., an Ethernet card), a communications port, a PCMCIA slot and card, etc. Software and data transferred via the communications interface 1124 may be in the form of signals, which may be electronic, electromagnetic, optical, or other signals as will be apparent to persons having skill in the relevant art. The signals may travel via a communications path 1126, which may be configured to carry the signals and may be implemented using wire, cable, fiber optics, a phone line, a cellular phone link, a radio frequency link, etc.

The computer system 1100 may further include a display interface 1102. The display interface 1102 may be configured to allow data to be transferred between the computer system 1100 and external display 1130. Exemplary display interfaces 1102 may include high-definition multimedia interface (HDMI), digital visual interface (DVI), video graphics array (VGA), etc. The display 1130 may be any suitable type of display for displaying data transmitted via the display interface 1102 of the computer system 1100, including a cathode ray tube (CRT) display, liquid crystal display (LCD), light-emitting diode (LED) display, capacitive touch display, thin-film transistor (TFT) display, etc. Computer program medium and computer usable medium may refer to memories, such as the main memory 1108 and secondary memory 1110, which may be memory semiconductors (e.g., DRAMs, etc.). These computer program products may be means for providing software to the computer system 1100. Computer programs (e.g., computer control logic) may be stored in the main memory 1108 and/or the secondary memory 1110. Computer programs may also be received via the communications interface 1124. Such computer programs, when executed, may enable computer system 1100 to implement the present methods as discussed herein. In particular, the computer programs, when executed, may enable processor device 1104 to implement the methods illustrated by FIGS. 1-10, as discussed herein. Accordingly, such computer programs may represent controllers of the computer system 1100. Where the present disclosure is implemented using software executed on hardware, the software may be stored in a computer program product and loaded into the computer system 1100 using the removable storage drive 1114, interface 1120, and hard disk drive 1112, or communications interface 1124.

The processor device 1104 may comprise one or more modules or engines configured to perform the functions of the computer system 1100. Each of the modules or engines may be implemented using hardware and, in some instances, may also utilize software executed on hardware, such as corresponding to program code and/or programs stored in the main memory 1108 or secondary memory 1110. In such instances, program code may be compiled by the processor device 1104 (e.g., by a compiling module or engine) prior to execution by the hardware of the computer system 1100. For example, the program code may be source code written in a programming language that is translated into a lower-level language, such as assembly language or machine code, for execution by the processor device 1104 and/or any additional hardware components of the computer system 1100. The process of compiling may include the use of lexical analysis, preprocessing, parsing, semantic analysis, syntax-directed translation, code generation, code optimization, and any other techniques that may be suitable for translation of program code into a lower-level language suitable for controlling the computer system 1100 to perform the functions disclosed herein. It will be apparent to persons having skill in the relevant art that such processes result in the computer system 1100 being a specially configured computer system 1100 uniquely programmed to perform the functions discussed above.

In accordance with an exemplary embodiment, the methods and processes as disclosed can be implemented on a non-transitory computer readable medium. The non-transitory computer readable medium may be a magnetic recording medium, a magneto-optic recording medium, or any other recording medium which will be developed in future, all of which can be considered applicable to the present invention in all the same way. Duplicates of such medium including primary and secondary duplicate products and others are considered equivalent to the above medium without doubt. Furthermore, even if an embodiment of the present invention is a combination of software and hardware, it does not deviate from the concept of the invention at all. The present disclosure may be implemented such that its software part has been written onto a recording medium in advance and will be read as required in operation.

As used herein, an element or step recited in the singular and preceded by the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional examples that also incorporate the recited features.

The patent claims at the end of this document are not intended to be construed under 35 U.S.C. § 112 (f) unless traditional means-plus-function language is expressly recited, such as “means for” or “step for” language being expressly recited in the claim(s).

It will be apparent to those skilled in the art that various modifications and variation can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for profile management of printers, the method comprising:
receiving, by a printer, a print job containing a color profile requirement from a user;
checking, by the printer, the color profile requirement for a color space match;
determining, by the printer, if the color space match of the color profile requirement is met by the printer;
checking, by the printer, access requirements for the color profile requirement for the user; and
printing, by the printer, the print job when the access requirement for the color profile requirement is met for the user.

2. The method according to claim 1, further comprising:
receiving, by the printer, an authenticator from the user for access to the multifunction; and
determining, by the printer, an access level for the user based on the authenticator received by the printer.

3. The method according to claim 2, further comprising:
printing, by the printer, the print job when the access level for the user is equal to or greater than the access lever for the print job.

4. The method according to claim 3, further comprising:
restricting, by the printer, access to the printer with a CMYK color space plus one or more additional colors to only a certain group of users, the certain group of users having access to all printers within a network of printers.

5. The method according to claim 3, further comprising:
requesting, by the printer, an access code from the user to execute the print job;
receiving, by the printer, the access code from the user to execute the print job; and
determining, by the printer, if the access code received from the user matches an access code for the user to execute the print job.

6. The method according to claim 2, wherein the access level for the user includes access to one or more of a printer with a CMYK color space or a printer with a CMYK color space plus one or more additional colors.

7. The method according to claim 2, wherein the checking by the printer the access requirements for the color profile requirement for the user comprises:
forwarding, by the printer, the authenticator received from the user to a remote server with a request to authenticate the user on the printer; and
receiving, by the printer, the access requirements for the color profile requirement for the user.

8. The method according to claim 2, wherein the authenticator received from the user on the printer comprises:
receiving, the biometric authenticator on a biometric authenticator device associated with the printer, the biometric authenticator device including one or more of a sensor, a scanning device, or an electronic reader, and wherein the biometric identifier of the user being at least one physiological characteristic of the user, and wherein the at least one physiological characteristic is selected from one or more of fingerprints, palm veins, face recognition, DNA (deoxyribonucleic acid), palm print, hand geometry, iris recognition, retina, and/or odor/scent;
receiving, the smart card on a card reader associated with the printer; and
receiving, by the printer, the authenticator from the user via a client device via a wireless communication protocol, the wireless protocol being a near-field communication (NFC) or a Bluetooth technology standard, and wherein the client device is a mobile device, a smart phone, or a wearable device.

9. The method according to claim 1, further comprising:
determining, by the printer, that the color space match of the color profile requirement is met by the printer when the printer can achieve a predetermined percentage of matching of a color space for the color print job.

10. The method according to claim 1, further comprising:
a plurality of users, each of the plurality of users having an access level, the access level for each of the plurality of users including no access to the printer with a CMYK color space, access to the printer with the CMYK color space, access to the printer with the CMYK color space plus one or more additional colors with an access code, and access to the printer with the CMYK color space plus the one or more additional colors without the access code.

11. The method according to claim 10, further comprising:
receiving, by the printer, a request to transfer the color print job to the at least one of the one or more of the plurality of printer with the CMYK color space plus a fifth color or more; and
forwarding, by the printer, the color print job to the at least one of the one or more of the plurality of printer with the CMYK color space plus the fifth color or more to be printed.

12. The method according to claim 1, further comprising:
notifying, by the printer, the user when the user does not have the access requirements for the color profile requirement for the color print job.

13. The method according to claim 1, wherein the printers comprise a plurality of printers, and one or more of the plurality of printers has a CMYK color space plus a fifth color or more, the method further comprising:
finding, by the printer, at least one of the one or more of the plurality of printers when the color print job requires the CMYK color space plus the fifth color or more; and
notifying, by the printer, the user of the at least one of the one or more of the plurality of printers with the CMYK color space plus the fifth color or more.

14. The method according to claim 1, further comprising:
receiving, by the printer, the color profile requirement of the print job in one or more color modes, the one or more color modes including one of CMYK, LAB, SRGB and Adobe® RGB;
converting, by the printer, the one or more color modes of the print job to a CMYK color space;
determining, by the printer, if the converted CMYK color space is met by the printer; and
printing, by the printer, the print job when the converted CMYK color space the printer meets match.

15. A non-transitory computer-readable medium having program instructions embodied therewith, the program instructions executable by a processor on a printer to cause the processor of the printer to perform a process comprising:
receiving a print job containing a color profile requirement from a user;
checking the color profile requirement for a color space match;
determining if the color space match of the color profile requirement is met by the printer;
checking access requirements for the color profile requirement for the user; and
printing the print job when the access requirement for the color profile requirement is met for the user.

16. The non-transitory computer-readable medium according to claim 15, further comprising:
receiving an authenticator from the user for access to the multifunction; and
determine an access level for the user based on the authenticator received by the printer.

17. The non-transitory computer-readable medium according to claim 16, further comprising:
printing the print job when the access level for the user is equal to or greater than the access lever for the print job.

18. The non-transitory computer-readable medium according to claim 17, further comprising:
restricting access to the printer with a CMYK color space plus one or more additional colors to only a certain group of users, the certain group of users having access to all printers within a network of printers.

19. The non-transitory computer-readable medium according to claim 17, further comprising:
requesting an access code from the user to execute the print job;
receiving the access code from the user to execute the print job; and
determining if the access code received from the user matches an access code for the user to execute the print job.

20. A printer comprising:
a processor configured to:
receive a print job containing a color profile requirement from a user;
check the color profile requirement for a color space match;
determine if the color space match of the color profile requirement is met by the printer;
check access requirements for the color profile requirement for the user; and
cause the print job to print when the access requirement for the color profile requirement is met for the user.
